(19) United States
(12) Patent Application Publication
(10) Pub. No.: US 2025/0083931 A1
(43) Pub. Date: Mar. 13, 2025

(54) METHOD AND SYSTEM FOR CONTROLLING A PARALLEL CRANE ON A WORKING MACHINE

(71) Applicant: Komatsu Forest AB, Umeå (SE)

(72) Inventors: Daniel LINDER, Umeå (SE); Fredrik TJERNBERG, Holmsund (SE)

(21) Appl. No.: 18/708,178

(22) PCT Filed: Nov. 4, 2022
(86) PCT No.: PCT/SE2022/051012

§ 371 Date: May 7, 2024

(30) Foreign Application Priority Data
Nov. 9, 2021 (SE) 2151370-0

(51) Int. Cl. B66C 13/46; A01G 23/00; A01G 23/08; B66C 13/48; B66C 23/42

(52) U.S. Cl. CPC B66C 13/46; B66C 13/48; A01G 23/003; A01G 23/08; B66C 23/42

(57) ABSTRACT

A method and a system for controlling a parallel crane on a working machine by means of TCP control. According to the method, the parallel crane has a crane arm system with crane parts with a lifting arm section with two parallel arms, a rocker arm with a telescoping push arm, which crane parts are articulately mutually connected and to the working machine and can be displaced through impact of actuators and activators, which are controlled and monitored by a control system by which direction and motion speed of the parallel crane Tool Center Point (TCP) controlled by an operator using joysticks in the working machine, by applying speeds for the various crane parts of the parallel crane. A characteristic is that the speeds of the various crane parts of the parallel crane are automatically determined by the control system based on the position of the various crane parts.

### TECHNICAL FIELD

The present invention relates to a method for controlling a crane with parallel guidance at a working machine by means of Tool Center Point control according to the preamble of claim 1. The present invention also relates to a system for controlling a crane with parallel guidance at a working machine according to claim 18.

### BACKGROUND

Crane-carrying working machines such as forestry machines in the form of harvesters or the like are usually equipped with a crane arm system comprising at least two mutually articulated arms (booms) one of which is configured to provide a parallel guidance. In the following, this type of crane arm system is termed parallel crane. The object of the parallel guidance is to facilitate and make handling of load with the crane more efficient by making it possible to keep an angle of the crane constant. As the angle is not changed when the crane is operated in the space, an improved production result can be obtained compared with cranes lacking parallel guidance.

A characteristic of a parallel crane is that it comprises a lifting arm section with two arms that mutually spaced travel in parallel with each other. Unlike for instance a knuckle-boom crane, which is equipped with a single conventional lifting arm, the parallel crane is, due to the lifting arm section with parallel arms, usually configured such that the distance to the foundation of the outer end of the rocker arm included in the crane, i.e. the Tool Center Point, is not changed when the crane is operated, implying that the gripping or harvester aggregate, sustained at the free end of the rocker arm can in an efficient manner be caused to move rectilinearly at displacement inwards/outwards from the working machine. Due to the parallel guidance, a parallel crane is thus particularly efficient for crane motion (horizontal displacements) inwards/outwards from the working machine unlike for instance a knuckle-boom crane, which is substantially configured to work at vertical lifting motions upwards/downwards.

A parallel crane on a working machine normally comprises a base on which the crane is rotatable about a vertical axis of rotation and a crane arm system intended to carry a load in a Tool Center Point (TCP) at an outer end of the crane arm system. With one end, the lifting arm section is articulately connected to the base. At the other end of the lifting arm section, a rocker arm (rocker boom) is articulately joined. The rocker arm is usually telescopically extendable and comprises a push arm for the purpose. The parallel crane also comprises an operating unit with one or more controllers (control means), buttons and/or joysticks (control sticks) configured to be operable by a crane operator to control the motions of the crane. To facilitate the operator's control of the TCP position in the space in a correct manner, the control of the mutual motions of the crane arms can advantageously be based on a so-called coordinate control system. Such systems can usually be switched between two various working modes (modes), i.e. a functional control mode and a TCP control mode. In the following, coordinate control of the TCP is called TCP control and implies that the operator's focus is moved from how each joint on the crane is to be controlled to only being concerned with how the TCP is to be controlled, i.e. how the TCP can be displaced in/out and up/down, respectively, to reach each desired position in the space. The crane arm motions are controlled automatically by a computer included in a control system for the crane. The conventional way of controlling a crane based on joystick impact of the motion of each boom part about a respective joint is called functional control in the following.

In TCP control, an operator usually uses two joysticks, whereby a first joystick is used for controlling the turning motions of the base and thereby the crane boom system in a horizontal plane about said vertical rotational axis, and a second joystick is used for controlling the TCP motion in a vertical plane in height Up/Down as well as for controlling the TCP motion in a horizontal plane In/Out with respect to the base of the crane. Normally, the left joystick x direction is used: Turning, y direction: in/out. Right joystick: x direction rotator and y direction up/down.

Slightly simplified, it could be said that prior art coordinate controls for cranes of the type indicated above “obey” the control command from the operator on the basis of the joystick impact as to choice of desired speed (joystick deflection) and positioning of the Tool Center Point (TCP) (in/out; lift/lower) at motion from a current start or initial coordinate position in an initial state in the space to a desired target coordinate position in the space.

In connection with the crane operator positioning the TCP, individual crane arm motions and mutual speeds in the crane arm system are regulated by a computer-based crane control by means of control signals from the respective joysticks 20a, 20b of the operating unit and a calculation model for controlling the TCP of the crane arm system, wherein the calculation model is established by the crane manufacturer in accordance with a predetermined control and monitoring strategy. Thus, when TCP control is used, the operator has no direct control of the position of the individual crane arms. Instead the crane control calculates how the individual crane arms are to be displaced to cause the TCP to follow the path and speed indicated by the crane operator via the control command on the operating unit.

As mentioned above, the crane on a harvester normally turns together with the driver's cabin about a vertical axis in the z direction for which purpose both are jointly sustained on a turntable, which forms part of the base 4 mentioned above, whereby the crane has a certain degree of freedom for motion due to its pivotable mounting about said vertical axis in the z direction. The lifting arm section 11 has a certain degree of freedom for motion due to its pivotable mounting on the base 4. The rocker arm 12, which is pivotably mounted on the lifting arm section 11, can move over a structural predetermined turning range, whereby said rocker arm 12 has a certain degree of freedom due to its pivotal mounting. Said rocker arm 12, which furthermore normally is telescopically extendable via a linearly movable push arm 13 is mounted in the rocker arm, such that it can be displaced over a structural predetermined range and has a degree of freedom for motion d due to its displaceable mounting. The arm system of a parallel crane (harvester crane) consequently has four degrees of freedom, comprising three rotational motions at the pivot joints between the arm parts and a linear translation motion for the push arm 13. The term degree of freedom or degrees of freedom refers to the number of independent motions that a crane arm system 11, 12, 13 of a crane can make with respect to a system of orthogonal coordinate axes in a three-dimensional space including a basis system with x, y and z axes that intersect each other in orthogonal main planes in the space.

Though computer-assisted TCP controls in parallel cranes 2 on working machines 1 have contributed to facilitating and making the work more efficient, there is always a desire to further improve both the efficiency of the TCP control system and the driving experience for the operator. To obtain high efficiency in parallel cranes 2 of a harvester, it is desirable for the individual operator to the widest possible extent to avoid a movement pattern or occurrence of the crane arm system 11, 12, 13 that is unwanted or unexpected and which can involve that also operators with a long time of experience behind them can feel uncomfortable and due to which inconveniences, it can be difficult to obtain satisfactory production results. Such unwanted movement pattern can include unexpected changes in speed between booms, unexpected changes of angles or unforeseen movement pattern between mutually articulated booms, when the crane arm system of the parallel crane in the TCP control mode is maneuvered in/out respectively up/down in the space. Furthermore, it could be mentioned that it can also be difficult for experienced operators to smoothly run functions together to avoid unwanted shaking in the crane and hence also in the machine.

### SUMMARY OF THE INVENTION

An object of the present invention is therefore to obtain a method for controlling a crane 2 with parallel guidance at a working machine 1 by means of TCP control, wherein the control results in improved efficiency and can provide better driving experience through combined operation for the operator. This object of the invention is obtained through application of a method for controlling a parallel crane at a working machine by means of TCP control according to the characteristics and features set forth in claim 1.

Another object of the invention is to obtain a system for controlling a parallel crane of a working machine. This object of the invention is obtained through a system for controlling a crane at a working machine having the characteristics and features set forth in claim 18.

According to a method, the speeds of the various crane arms 11, 12, 13 of the crane 2 by means of the speeds for the various crane parts is automatically determined by the control system based on the position of the various crane parts relative to their mutual angle positions and the telescope length of the rocker arm as well as by way of parameter adjustment of the speeds of the various crane parts by means of correction factor curves stored as data in the control system. Data comprising said correction factor curves can of course also be retrieved from some external data base, which via an interface can communicate with the control system. Alternatively, the correction factor curves can comprise software in the form of a data program stored in the control system with suitable mathematical calculation functions, an executable data application or the like, which correspondingly could parameter-adjust the automatically determined speeds of the crane parts depending on the mutual angle positions of the crane parts, so as to compensate for various types of constructive geometric factors in the crane arm system, which can affect the motion characteristics of the crane arms system in various directions of the TCP.

As the parameter adjustment takes place on the basis of correction factor curves stored as data and measurement data comprising the mutual positions and speed of the arm parts continuously are addressed from sensing elements and sensors in the arm system to the control system, it should be understood that the crane is controlled in a dynamic and momentary manner in accordance with the method according to the invention.

The invention is based on the insight that improved efficiency could be obtained by a manner of controlling the parallel crane, implying that the parallel crane can be manoeuvred inwards and outwards from the working machine in the normal motion range for felling, trimming and cutting up of the wood into timber in specific lengths with the least possible use of the ejection boom of the telescopic rocker. Instead it is desired to make it possible to exploit the actuators and activators of the parallel crane close to the base to the widest possible extent, and the large gear ratio offered by the crane in parallel configuration without having to give up a predictable and good operating experience for the operator as to the motions and speed of the crane parts. However, it is not only about speed as regards crane motions and speed, it is to a high degree also about how these partial parameters, speed and providing a motion accuracy of the arm system, as expected by the operator, can be provided by the control system to obtain high productivity with the crane. By means of the measures and steps indicated in claim 1, the present invention has made this possible.

In a second embodiment of the invention, the speeds of the various crane parts are automatically determined when the TCP by means of the joysticks is operated in one of the following ways; outwards or inwards in a horizontal plane relative to the working machine; upwards or downwards in a vertical plane relative to the working machine.

### DESCRIPTION OF FIGURES

In the following, the invention is described in detail with reference to the accompanying drawings, in which;

FIG. 1a shows a side view of a working machine in the form of a harvester that is equipped with a parallel crane controlled by a method according to the present invention,

FIG. 2 shows a schematic principal view of joysticks (control sticks) in the cabin of a harvester according to FIG. 1 and configured to be impacted by a crane operator for controlling and monitoring the parallel crane,

FIG. 3 schematically shows a block diagram of the mode of operation of a parallel crane control that can be controlled by a method according to the present invention,

FIG. 4 schematically shows a parallel crane with crane control according to the invention with four degrees of freedom of movement in a basic coordinate system (x, y, z), which is controlled by a method according to the invention,

FIG. 5 schematically shows a flow chart describing start and stop conditions of a harvester equipped with a parallel crane controlled by a method according to the present invention,

FIG. 6 schematically shows a graph (correction factor curve) describing the speed which in percent (%) is steered out to the telescope boom relative to a rocker arm angle in degrees) (°) when the arm system of the parallel crane at a horizontal plane is run outwards by means of a joystick of a harvester equipped with a crane that is controlled by a method according to the present invention,

FIG. 7 schematically shows a graph (correction factor curve) describing the speed which in percent (%) is steered out to the rocker arm relative to a relative telescope length when the arm system of the parallel crane in a horizontal plane is run inwards by means of a joystick of a harvester equipped with a crane that is controlled by a method according to the present invention,

FIG. 8 schematically shows a graph (correction factor curve) describing the speed which in percent (%) is steered out to lifting arms relative to a rocker arm angle in degrees) (°) when the arm system of the parallel crane in a vertical plane is raised by means of a joystick of a harvester equipped with a crane that is controlled by a method according to the present invention,

FIG. 9 schematically shows a graph (correction factor curve) describing the speed which in percent (%) is steered out to lifting arms relative to a rocker arm angle in degrees) (°) when the arm system of the parallel crane in a vertical plane is lowered by means of a joystick of a harvester equipped with a crane that is controlled by a method according to the present invention,

FIG. 10 schematically shows a graph (correction factor curve) describing the speed which in percent (%) is steered out to a telescope boom relative to a rocker arm angle in degrees) (°) when the arm system of the parallel crane in a vertical plane is raised by means of a joystick of a harvester equipped with a crane that is controlled by a method according to the present invention,

FIG. 11 schematically shows a graph (correction factor curve) describing the speed which in percent (%) is steered out to a telescope boom relative to a rocker arm angle in degrees) (°) when the arm system of the parallel crane in a vertical plane is lowered by means of a joystick of a harvester equipped with a crane that is controlled by a method according to the present invention,

FIG. 12 schematically shows a graph (correction factor curve) describing speed compensation in percent (%) depending on the TCP outlying length relative to the rocker arm angle in degrees) (°) when the arm system of the parallel crane in a horizontal plane is run outwards by means of a joystick of a harvester equipped with a crane that is controlled by a method according to the present invention,

FIG. 13 schematically shows a graph (correction factor curve) describing speed compensation in percent (%) depending on the TCP outlying length relative to the rocker arm angle in degrees) (°) when the arm system of the parallel crane in a horizontal plane is run inwards by means of a joystick of a harvester equipped with a crane that is controlled by a method according to the present invention,

FIG. 14 schematically shows a graph (correction factor curve) describing speed compensation in percent (%) depending on the TCP outlying length in percent (%), when the arm system of the parallel crane in a vertical plane is lifted by means of a joystick of a harvester equipped with a crane that is controlled by a method according to the present invention,

FIG. 15 schematically shows a graph (correction factor curve) describing speed compensation in percent (%) depending on the TCP outlying length in percent (%) when the arm system of the parallel crane in a vertical plane is lifted/lowered by means of a joystick of a harvester equipped with a crane that is controlled by a method according to the present invention,

FIG. 16 schematically shows a graph (correction factor curve) describing speed compensation in percent (%) depending on the TCP outlying length in percent (%) when the arm system of the parallel crane turns in a horizontal plane about its central pivoting axis by means of a joystick of a harvester equipped with a crane that is controlled by a method according to the present invention,

### DESCRIPTION OF EMBODIMENTS

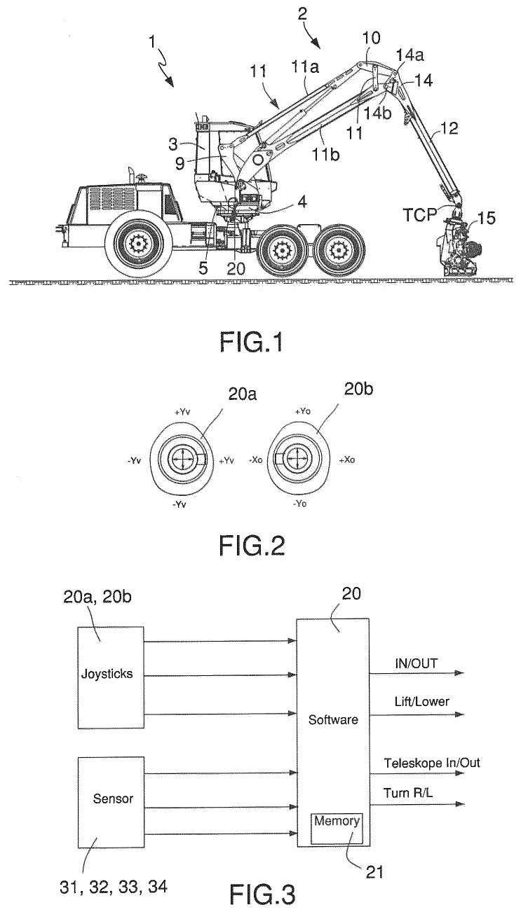

FIG. 1 shows a working machine 1 in the form of a frame-controlled harvester with a parallel crane 2, which together with a driver's cabin 3 in a horizontal plane is pivotably sustained on a base 4 comprising a rotatable turntable 5 on the working machine chassis 6 or frame. The parallel crane 2 is equipped with a crane control generally denoted 20, enabling an operator (not shown) to control the crane by means of so-called coordinate control based on the TCP. The parallel crane 2 substantially comprises a lifting arm section generally denoted 11 as well as a rocker arm 12 at the free end of which (TCP) a harvester aggregate 15 is sustained.

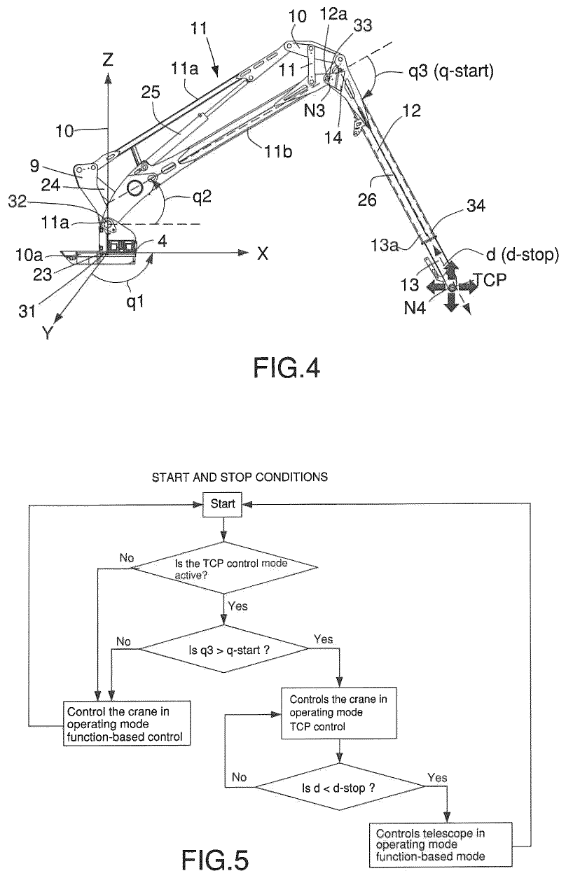

Also, with reference to FIG. 4, it is shown that the lifting arm section 11 comprises a parallel guidance with two substantially parallel arms 11a, 11b, one 11b (lifting arm) of which at a first end is directly articulately connected with the base 4, while the second arm 11a (parallel arm) is indirectly articulately connected with the base via an intermediate first linkage arm 9. The rocker arm 12 is at one end connected to a yoke 14, forming a two-armed lever arm with two mutually spaced pivot points 14a, 14b at a respective end of the yoke. One end of the yoke 14 is at 14a indirectly articulately connected with a second end of the first arm 11a of the lifting arm section 11 via a second linkage arm 10, while the other end of the yoke 14 at 14b is directly articulately connected with a second end of the second arm 11b of the arm section 11. A support link 11 is articulately disposed between said second linkage arm 10 and the second end of the second arm 11b of the lifting arm section 11

According to the invention, the parallel crane 2 with the computer-based crane control 20 sustained on the working machine 1 can be configured to be switched to various working modes (operating modes) of which; a first operating mode could comprise operating mode for coordinate control of the TCP, i the following called TCP control, whereby the arm system 11, 12, 13 of the parallel crane 2 is controlled and monitored on the basis of the desired motions from the TCP. The crane control 20 can also be configured, such that the crane can be operated in another operating mode for conventional manual control of the crane and thus via separate control and monitoring of each separate actuator of the crane, which in the following is called functional control of the crane. The crane control 20 can suitably be configured, such that an operator, via a selector switch or similar operator interface included in the crane control 20, can easily switch between said respective operating modes for the crane. In an embodiment, it is also imaginable that the operating modes could be switched automatically depending on the crane configuration, selected functions in the control system or otherwise the status of the machine.

FIGS. 2 and 3 show in more detail how the parallel crane 2 is configured to be controlled and monitored by an operator (not shown) in the driver's cabin 3. For the purpose, the crane control 20 can comprise a first joystick 20a for the left hand respectively a second joystick 20b for the right hand. The control command generated by the operator via said joysticks 20a, 20b is transferred via communications buses to the crane control 20, which in turn, through activation of actuators and activators 23, 24, 25, 26 (see FIG. 4) operate the various crane parts; the turntable 5 of the base 4, the lifting arm section 11, the rocker arm 12 and the push arm 13 via a control interface in the crane control. The crane control comprises control means 21 for controlling the parallel crane, which control means comprise software and/or data stored in a data processing unit, and which comprise correction factor curves to, through parameter adjustment, automatically determine the speeds of the various crane parts 11, 12, 13 and the speed at turning of the parallel crane 2 in a horizontal plane on the turntable 5 of the base 4.

FIG. 4 shows how the parallel crane 2 sustained on said turntable 5 is pivotable about a vertical joint shaft 10a and has a first degree of freedom q1 for motion due to said pivotable mounting, the lifting arm section 11 (comprising the two parallel arms 11a, 11b) is pivotable on a first horizontal joint shaft 11a and has a second degree of freedom q2 for motion due to its pivotable mounting. The rocker arm 12 is pivotably mounted on the lifting arm section 11 via a second horizontal joint shaft 12a and has a third degree of freedom q3 for motion due to its pivotable mounting, the push arm 13, which is slidably (telescopically) mounted in the rocker arm 12 via a linear slide control and pushsable over a structural pre-determined sliding area and has a fourth degree of freedom d for motion due to its displaceable mounting. FIG. 4 also shows a basic coordinate system x, y, z, which is an orthogonal coordinate system, wherein the z axis coincides with the axis of rotation of the turntable with the vertical joint shaft 10a, and the x axis coincides with the direction of the crane 2 outwards and outlying length from the working machine 1. The TCP motions inwards/outwards from the working machine 1 take place in the horizontal plane, i.e. in the xy plane.

The measuring elements 31, 32, 33, 34 are arranged to the pivotable assemblies 10a, 11a, 12a, 13a between the various crane parts; the turntable 5, the lifting arm section 11, the rocker arm 12 and the push arm 13. The measuring elements 31, 32, 33, 34, measuring the state of the turntable 5 (the rotation angle relative to a given basic state), the state of the lifting arm section 11 and the rocker arm 12 relative to each other can comprise angle sensors that measure rotational motions in each joint in the crane arm system, while the measuring element 34 that measures the translation motion of push arm 13 can comprise a linear measurement sensor. The measuring elements 31, 32, 33, 34 comprise sensors that are connected to the crane control 20 in such a manner that the crane control 20 can receive measuring data produced by the measuring elements.

As shown in FIG. 4, the crane 1 comprises a three-axis coordinate system with x, y and z axes intersecting each other in orthogonal main planes in the space. Based on information from the above-mentioned measuring elements 31, 32, 33, 34, the mutual position of the constituent crane booms can be determined and thereby also the structural state of the crane in the three-axis coordinate system.

### Start and Stop Conditions for TCP Control

FIG. 5 schematically shows a flow chart describing start and stop conditions of a harvester equipped with a parallel crane controlled by a method according to the present invention, Then the TCP control function is not active (start angle “q-start” not obtained, or the function not switched on by the operator), the functions will be controlled as usual with functional control. If the TCP control function is switched on, it will control the crane when the angle of the rocker arm 12, i.e. the third degree of freedom q3 for motion of the parallel crane is above the start angle q-start, which in the present embodiment of the invention relates to an angle q3 that is lower than −150°. The TCP control function stops controlling the telescope push arm 13, when the length of the telescope, i.e. the fourth degree of freedom d for motion falls below the stop length (telescope) (mm), which telescope stop length is denoted “d-stop”. Settings; Start/stop conditions; Start angle (rocker arm) −150.0°; Stop length (telescope) 20 mm.

### Steering Out Speeds on the Crane at TCP Displacement in the Xy Plane (Out/in)

According to the invention, various speeds are steered out to the push arm of the telescope, the rocker arm and lifting/lowering, when the parallel crane in the xy plane is run inwards/outwards on said first and second joysticks 20a, 20b (Crane In and Crane Out). It should be understood that the expression “speed steered out to” a respective component that is included in the crane arm in the following relates to the volume flow of hydraulic fluid, which, via a directional valve (not shown) included in the crane control 20 is guided out to the actuators and activators 23, 24, 25, 26 operating a respective component 5, 11, 12, 13 having a degree of freedom q1, q2, q3, d for motion. Higher volume flow thus implies higher motion speed of the relevant component.

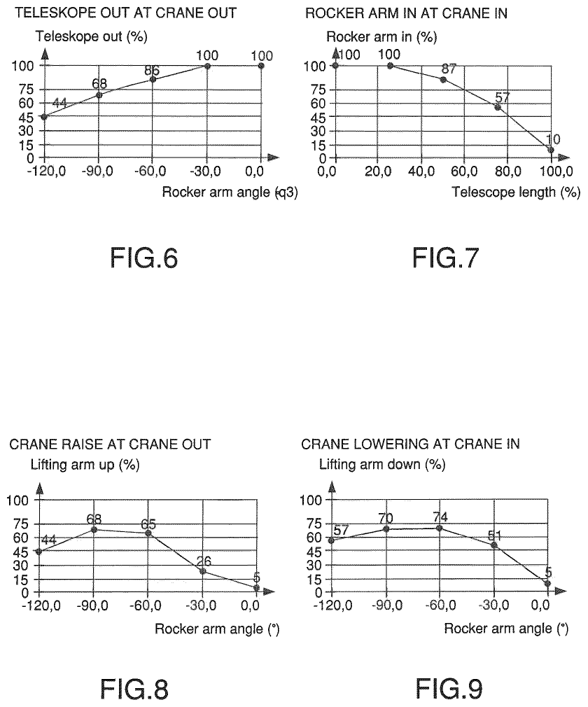

FIG. 6 schematically shows a graph (correction factor curve) describing the speed which in percent (%) is steered out to the telescoping push arm 13 of the rocker arm 12 relative to the rocker arm angle q3 in terms of degrees, when the crane arm system is run outwards in the xy plane by means of joystick 20a, 20b. When the TCP by means of the joysticks (20a, 20b) in a horizontal plane xy is run outwards relative to the working machine 1, the speed is restricted at which the push arm 13 telescopes out from the rocker arm 12 through parameter adjustment of the speed of the push arm 13 based on the momentary angle position q3 of the rocker arm 12. When an operator through joystick impact 20a, 20b instructs the TCP to move outwards in the xy plane, the speed Vd is set to the push arm 13 of the telescope as a percentage of the joystick deflection of the crane, wherein said percentage depends on the momentary rocker arm angle q3. As appears from the graph, the motion speed of the push arm 13 at outward motion is reduced as along as the rocker arm angle q3 of the crane is lower than a certain rocker arm angle q3, which in this case i determined to be −30°. Example: if the crane arm system 2 and hence the TCP is run outwards by the operator in the xy plane at 50% joystick deflection, and the value of the diagram is 50% as regards the momentary rocker arm angle q3, the push arm 13 will be steered out at a 25% speed.

FIG. 7 schematically shows a graph (correction factor curve) describing the speed which in percent (%) is steered out to the rocker arm 12 relative to the telescope length in percent (%), when the crane arm system is run inwards in the xy plane by means of a joystick 20a, 20b. When the TCP by means of the joysticks 20a, 20b in a horizontal plane xy is run inwards relative to the working machine 1, the speed of the rocker arm 12 is restricted by parameter adjustment based on the momentary telescope length d of the rocker arm 12 as a percentage of the entire motion range of the telescope.

When the operator by impact of the joysticks 20a, 20b commands the TCP to move inwards in the xy plane, the speed of the push arm 13 is set at the same speed as the joystick deflection, i.e. 1:1, while the speed of the rocker arm 12 is instead restricted by the state of the push arm 13, i.e. the telescope length. Example: if the crane in is steered at 50%, and the value of the diagram above gives 10% at a momentary telescope length, the rocker arm 12 is steered by 10% of 50%, which is 5%. When the telescope length is lower than the set stop length d-stop=20 mm for the telescope, the telescope is turned off, and the rocker arm 12 subsequently gets a 1:1 ratio to the joystick command.

FIG. 8 schematically shows a graph (correction factor curve) describing the speed which in percent (%) is steered out to the lifting arms section 11 relative to the rocker arm angle q3 when the arm system in a vertical plane in xz direction, yz direction is raised by means of a joystick 20a, 20b.

As indicated initially, parallel cranes are configured to cause the TCP to follow a linear path at outward motion of the crane. However, it has turned out that this path in practice is seldom perfect, as it can generally dip somewhat when the crane is folded outwards. To obtain a straight line of the TCP, it has proven suitable to compensate for this deviation by lifting up the TCP somewhat, when the crane is run outwards and cause the TCP to be lowered somewhat when the crane is run inwards. In an embodiment of the invention, when the crane is run outwards, lifting of the crane is thus steered out as a percentage on the crane based on the momentarily occurring rocker arm angle q3. If, for example, crane out is steered out by 50%, and the value in the diagram is 50%, the lifting of the crane will be steered out at a 25% speed. When the TCP by means of the joysticks 20a, 20b in a horizontal plane xy is run outwards relative to the working machine 1, the speed of the lifting arm section 11 is restricted by parameter adjustment based on the momentary angle position q3 of the rocker arm 12.

FIG. 9 schematically shows a graph (correction factor curve) describing the speed which in percent (%) is steered out to the lifting arm section 11 relative to the rocker arm angle q3 when the arm system in a vertical plane in xz direction, yz direction is lowered by means of a joystick 20a, 20b. When the TCP by means of the joysticks 20a, 20b in a horizontal plane xy is run inwards relative to the working machine 1, the speed of the lifting arm section 11 is restricted by parameter adjustment based on the momentary angle position q3 of the rocker arm 12. This means that when the operator by impacting the joysticks 20a, 20b commands the TCP to move inwards (crane in), the lifting arm section 11 is steered down (crane lowering) as a percentage on the crane and based on the monetary rocker arm angle q3 of the crane. If the crane is lifted/lowered or the telescope push arm 13 simultaneously is run from the joystick/rocker, the joystick movements will be added to the calculated steering out in a manner that enables the joysticks to control the individual functions between maximum speed at the one direction to maximum speed at the other direction.

### Steering Out Speeds at Crane Lifting/Lowering

To give a higher speed at the TCP in vertical direction closest to the working machine 1, the telescope push arm 13 is automatically run in when lifting and the telescope arm 13 out when the TCP is lowered. This means that the harvester aggregate 15 can quickly be lifted over the working machine 1 wheel, and subsequently the harvester aggregate 15 can be lowered towards the ground again. An operation wherein the operator according to prior art technique for crane operation normally uses the telescope push arm 13.

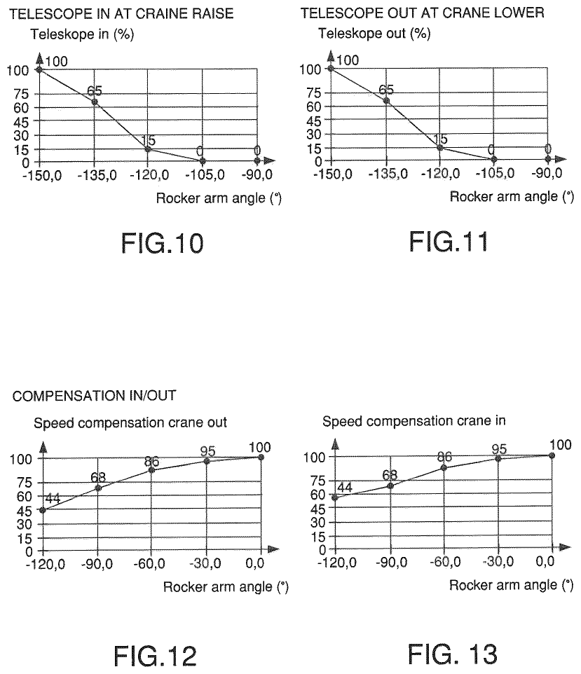

FIG. 10 schematically shows a graph (correction factor curve) describing the speed which in percent (%) is steered out to the telescope push arm 13 relative to the rocker arm angle q3, when the parallel crane arm system in a vertical plane is raised by means of a joystick 20a, 20b. When the TCP by means of the joysticks 20a, 20b in a vertical plane xz, yz is run upwards relative to the working machine 1, the speed is restricted at which the push arm 13 telescopes into the rocker arm through parameter adjustment based on the momentary angle position q3 of the rocker arm 12. At instructed crane lift, the telescope push arm 13 is steered in as a percentage on the operator's joy stick deflection 20a, 20b on instructed crane lift based on predetermined values stemming from the momentary rocker arm angle q3 of the rocker arm 12. If, for example, crane lift is steered out by 50%, and the value in the diagram is 65%, the telescope push arm 13 at inward motion will be steered out at 50% of 70%, i.e. 35% speed.

FIG. 11 schematically shows a graph (correction factor curve) describing the speed which in percent (%) is steered out to the telescope push arm 13 relative to the rocker arm angle q3, when the parallel crane arm system in a vertical plane in xz direction, yz direction is lowered by means of joystick 20a, 20b. When the TCP by means of the joysticks 20a, 20b in a vertical plane xz, yz is run downwards relative to the working machine 1, the speed is restricted at which the push arm 13 telescopes out from the rocker arm through parameter adjustment based on the momentary angle position q3 of the rocker arm 12. At crane lowering, the telescope is steered out as a percentage on crane lowering based on the momentary rocker arm angle q3 of the crane. At crane lift, the telescope push arm 13 stops at set stop length (d-stop) and at crane lowering, the end position restriction determines that the telescope push arm 13 brakes in towards an outer end position. If the rocker arm 12 is used simultaneously, it is added to the steering out in a manner that gives it clearance from maximum speed in to maximum speed out. More specifically, if the telescope push arm 13 simultaneously is run from the rocker arm 12, the joystick motion will be added to the calculated steering out in a manner that enables the rocker arm 12 to guide the telescope push arm 13 between maximum speed in one direction to maximum speed in the opposite direction.

### Compensation of Speed

The crane geometry and the mutually varying positions of the pivot points also mean that even though the functions mentioned above can cause the TCP to move along a line inwards and outwards, respectively, from the working machine 1, the TCP speed will vary along the way and be much slower longer out. The same applies to lifting/lowering, i.e. that the longer out the TCP, the faster the TCP will move upwards/downwards with the same lift/lower command. This is compensated for by correction factor curves that rescale the operator's crane in/out command based on the momentary angle q3 of the rocker arm 12 and also rescale the operator's lift/lower command depending on the momentary length of the crane (in x direction, y direction). In this manner, the TCP can have a more even speed in/out and up/down independently of the crane's momentary geometric position.

FIG. 12 schematically shows a graph (correction factor curve) describing speed compensation in percent (%) depending on the TCP outlying length relative to the rocker arm angle q3 when the arm system of the parallel crane in a horizontal plane in the x direction is run outwards by means of a joystick 20a, 20b. When the TCP (Tool Center Point) by means of the joysticks 20a, 20b in a horizontal plane xy, yz is run outwards relative to the working machine 1, the speed is restricted at which the TCP moves away from the working machine through parameter adjustment based on the momentary angle position q3 of the rocker arm 12 and in such a manner that the relatively high initial speed restriction of the TCP decreases as the momentary angle position q3 of the rocker arm 12 increases.

FIG. 13 schematically shows a graph (correction factor curve) describing speed compensation in percent (%) depending on the TCP outlying length relative to the rocker arm angle q3 when the arm system of the parallel crane in a horizontal plane is run outwards by means of a joystick 20a, 20b. When the TCP by means of the joysticks 20a, 20b in a horizontal plane xy, yz is run inwards relative to the working machine 1, the speed is restricted at which the TCP approaches the working machine through parameter adjustment based on the momentary angle position q3 of the rocker arm 12 and in such a manner that initially relatively low or absence of speed restriction of the TCP increases as the momentary angle position q3 of the rocker arm 12 decreases. Moreover, the speed of the various crane parts 11, 12, 13 is automatically determined depending on the total outlying length of the crane parts 11, 12, 13 in the x direction from the working machine 1.

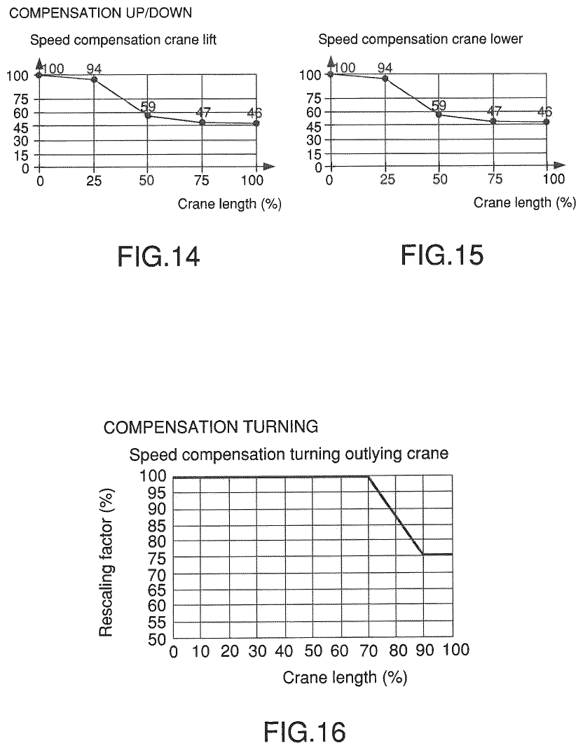

FIG. 14 schematically shows a graph (correction factor curve) describing speed compensation in percent (%) depending on the TCP outlying length in percent (%) when the arm system of the parallel crane in a horizontal plane in the xz direction, yz direction is lifted by means of a joystick 20a, 20b.

FIG. 15 schematically shows a graph (correction factor curve) describing speed compensation in percent (%) depending on the TCP outlying length in percent (%) when the arm system of the parallel crane in a vertical plane is lifted/lowered by means of a joystick. When the TCP by means of the joysticks 20a, 20b in a vertical plane xz, yz is run upwards relative to the working machine 1, the speed is restricted at which the TCP is displaced through parameter adjustment depending on the total outlying length of the crane parts 11, 12, 13 in the x direction in such a manner that the speed restriction increases as the total outlying length of the crane parts in the x direction increases.

FIG. 16 schematically shows a graph (correction factor curve) describing speed compensation in percent (%) depending on the TCP outlying length in percent (%) when the arm system of the parallel crane turns in a vertical plane about its central pivoting axis by means of a joystick. The turning speed of the parallel crane at certain angle positions q1 about said joint shaft is determined in such a manner that the speed restriction increases when the total outlying length of the crane parts 11, 12, 13 in x direction from the working machine is at a predetermined outlying length. Furthermore, the speed restriction increases when the total outlying length of the crane parts (11, 12, 13) in the x direction from the working machine is at an outlying length of between 70-100% of the maximum total outlying length of the crane parts.

As appears from FIG. 5, the TCP control of the parallel crane is disconnected if at least one of the following requirements are met; —TCP control mode for the control system 20 is not actively started by the operator; —the momentary angle position q3 of the rocker arm 12 is less than a predetermined value, which can be, but not necessarily is −150°.

1. A method for controlling a parallel crane on a working machine by a Tool Center Point (TCP) control according to which method, the parallel crane has a crane arm system with crane parts, comprising at least a lifting arm section configured to provide a parallel operation of the crane tip to the foundation when the crane is operated inwards/outwards from the working machine, a rocker arm with a telescoping push arm, which crane parts are articulately, mutually connected and to the working machine and can be displaced relative to each other and to the working machine by the influence of actuators and activators that are controlled and monitored by a control system of the working machine, and in which method direction and motion speed are obtained for the parallel crane Tool Center Point (TCP), which is controlled by an operator using joysticks in the working machine, by applying speeds for the various crane parts of the parallel crane, wherein the speeds of the various crane parts of the parallel crane are automatically determined by the control system when the Tool Center Point (TCP) is operated in one of the following ways; outward or inward in a horizontal plane (xy) relative to the working machine; upwards or downwards in a vertical plane (xz, yz) relative to the working machine based on the position of the various crane parts relative to their mutual angle positions (q2, q3) and the telescope length of the rocker arm as well as through parameter adjustment of the speeds of the various crane parts by correction factor curves and based on at least one of the following measures;
a) when the Tool Center Point (TCP) is run outwards relative to the working machine, the speed is restricted at which the push arm telescopes out from the rocker arm through parameter adjustment of the speed of the push arm based on the momentary angle position (q3) of the rocker arm;
b) when the Tool Center Point (TCP) is run inwards relative to the working machine, the speed of the rocker arm is restricted on the momentary telescope length of the rocker arm until the telescope length falls below a predetermined stop length (d-stop) after which the telescope is turned off and the rocker arm acquires a 1:1 relationship to lever command;
c) when the Tool Center Point (TCP) is run upwards relative to the working machine, the speed is restricted at which the push arm telescopes into the rocker arm through parameter adjustment based on the momentary angle position (q3) of the rocker arm;
d) when the Tool-Center-Point (TCP) is driven downward relative to the working machine, the speed is restricted at which the push arm telescopes out from the rocker arm through parameter adjustment based on the momentary angle position (q3) of the rocker arm.

2. The method according to claim 1, wherein when the Tool Center Point (TCP) by the joysticks in a horizontal plane (xy) is run outwards relative to the working machine, the speed of the lifting arm section is restricted through parameter adjustment based on the momentary angle position (q3) of the rocker arm.

3. The method according to claim 1, wherein when the Tool Center Point (TCP) by the joysticks in a horizontal plane (xy) is run inwards relative to the working machine, the speed of the lifting arm section is restricted through parameter adjustment based on the momentary angle position (q3) of the rocker arm.

4. The method according to claim 1, wherein when the Tool Center Point (TCP) by the joysticks in a horizontal plane (xy), the vertical plane (yz) is run outwards relative to the working machine, the speed is restricted at which the TCP moves away from the working machine through parameter adjustment based on the momentary angle position (q3) of the rocker arm and in such a manner that the relatively high initial speed restriction of the TCP decreases as the momentary angle position (q3) of the rocker arm increases.

5. The method according to claim 1, wherein when the Tool Center Point (TCP) by the joysticks in a horizontal plane (xy, yz) is run inwards relative to the working machine, the speed is restricted at which the TCP approaches the working machine through parameter adjustment based on the momentary angle position (q3) of the rocker arm and in such a manner that the initially relatively low or the absence of speed restriction increases as the momentary angle position (q3) of the rocker arm decreases.

6. The method according to claim 1, wherein the speed of the crane parts is automatically determined depending on the total outlying length of the crane parts in the x direction from the working machine.

7. The method according to claim 1, wherein when the Tool Center Point (TCP) by the joysticks in a vertical plane (xz, yz) is run upwards relative to the working machine, the speed is restricted at which the TCP is displaced through parameter adjustment depending on the total outlying length of the crane parts in the x direction in such a manner that the speed restriction increases as the total outlying length of the crane parts in the x direction increases.

8. The method according to claim 1, wherein when the Tool Center Point (TCP) by the joysticks in a vertical plane (xz, yz) is run downwards relative to the working machine, the speed is restricted at which the TCP is displaced through parameter adjustment depending on the total outlying length of the crane parts in the x direction in such a manner that the speed restriction increases as the total outlying length of the crane parts in the x direction increases.

9. The method according to claim 1, wherein the parallel crane is pivotably sustained on the working machine and is adjustable in certain angle positions (q1) in a horizontal plane about a vertical joint shaft (z direction), and the turning speed of the parallel crane about said joint shaft is automatically determined based on the total outlying length of the crane parts in x direction from the working machine.

10. The method according to claim 1, wherein the turning speed of the parallel crane at certain angle positions (q1) in a horizontal plane about said joint shaft is determined in such a manner that the speed restriction increases when the total outlying length of the crane parts in x direction from the working machine is in a predetermined outlying length.

11. The method according to claim 10, wherein the speed restriction increases when the total outlying length of the crane parts in the x direction from the working machine is at an outlying length of between 70-100% of the maximum total outlying length of the crane parts.

12. The method according to claim 1, wherein the TCP control of the parallel crane is inactive if at least one of the following requirements are met; TCP control mode for the control system is not actively started by the operator; the momentary angle position (q3) of the rocker arm is less than a predetermined value (q-start), which can be, but not necessarily is −150°.

13. A system for controlling a parallel crane on a working machine, such as a harvester or similar crane-equipped vehicle intended for wood handling by the TCP control, wherein the system comprises a controller for controlling the parallel crane by the method according to claim 1.

14. The system according to claim 13, comprising a data processor controlling the motions of the parallel crane with a programmable software in the data processor, and the controller comprises software and/or data stored in the data processor.
